(19) United States
(12) Patent Application Publication
(10) Pub. No.: US 2008/0052023 A1
(43) Pub. Date: Feb. 28, 2008

(54) Method for color matching

(76) Inventor: Wilhelm Kettler, Wuppertal (GL)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/894,433

(22) Filed: Aug. 22, 2007

Related U.S. Application Data
(60) Provisional application No. 60/839,347, filed on Aug. 22, 2006.

(51) Int. Cl. G06F 19/00

(52) U.S. Cl. 702/82

(57) ABSTRACT

The invention relates to a method for color matching a reference color formulation to a defined color shade standard. The method comprises the steps 1. Measuring the reflectance spectrum R_{ST} of a color shade standard, 2. Mixing a paint according to a recipe for the color shade standard and applying the paint to a substrate, 3. Measuring the reflectance spectrum R_{PT} of the applied paint, 4. Recalculating the theoretical reflectance spectrum R_{RPT} for the recipe of the applied paint, 5. Calculating the difference spectrum ΔR between the measured reflectance spectrum R_{PT} of the applied paint and the recalculated reflectance spectrum R_{RPT}, 6. Adjusting the reflectance spectrum R_{ST} of the color shade standard with the difference spectrum ΔR, 7. Calculating a recipe on basis of the modified reflectance spectrum R_{STM}, 8. Mixing a paint according to the recipe and applying the paint to a substrate.

### CROSS-REFERENCE TO RELATED APPLICATION

This application claims priority under 35 U.S.C. §119 from U.S. Provisional Application Ser. No. 60/839,347 (filed Aug. 22, 2006), the disclosure of which is incorporated by reference herein for all purposes as if fully set forth.

### FIELD OF INVENTION

The invention relates to a method for color matching a reference color formulation to a defined color shade standard. The process has applications in the field of color-imparting and special-effect-imparting surface coatings. It can be used in color laboratories, in particular in matching color shades of unknown pigmentation, as well as in production of paints in matching paint batches to a defined color shade standard.

### DESCRIPTION OF RELATED ART

The matching of shades of unknown pigmentation is a central problem in all coloristic areas of a paint company. If color standards have to be matched and tinting is to be done, the number of always required tinting steps is a decisive measure for the economic efficiency of the process. If no measuring and analysis techniques are available, the number of tinting steps needed to develop a color shade is inevitably closely connected to the experience of the respective colorist. The absence of well-skilled personnel then always leads to a significant increase of expenses for the tinting process.

When matching color shades of unknown pigmentation, nowadays complete possibilities of metrological support is exploited. With a view to support the elaboration process of matching colors of unknown pigmentation further instrumentally, various methods have been developed and are applicable from a theoretical point of view. The diversity of the procedures in practical use already indicates that all of these approaches are of approximate nature.

The first step of elaboration of a color shade within a given resin system is the recipe calculation on the basis of reflectance spectroscopy and an appropriate radiative transfer model to describe the diffusion of light through particulate media. Only for effect color shades generally an additional step of microscopic image analysis to identify the effect-mediating components is carried out in advance. The sprayed-out formula worked out by means of recipe calculation may noticeably deviate from a satisfactory match for several reasons: (i) Limitations of the theoretical radiative transfer model when handling the non-linearities between optical material parameters and the respective pigment volume concentration, (ii) interactions between the pigments leading to larger agglomerates depending on the pigment to volume ratio, (iii) scaling up problems if laboratory elaborations have to be manufactured in production under completely different side conditions, (iv) deviations in the physical structure of the embedding medium compared to the calibration window, (v) process errors as incorrect weighed-in quantities, wrong temperatures, unacceptable production or application conditions.

Visual estimation of the correction is increasingly more difficult with larger color differences, or when complex adjustments of all colorants of a formulation are required. If the remaining color differences are unacceptable the determined recipe has to be modified in further steps until it hits the given acceptance target. In order to support the tinting process with the introduction of computer-aided color recipe calculation in color laboratory and production, methods have been developed to accelerate the tinting process metrologically and free from the experience of colorists as far as possible. All of these methods use special algorithms of recipe calculation based on the 2-flux model of Schuster-Kubelka-Munk (P. Kubelka and F. Munk, “Ein Beitrag zur Optik der Farbanstriche”, T. Tech. Phys. 12, p. 593, 1931) for isotropically reflecting surface coatings or multi-flux models for anisotropically reflecting special effect colors (P. S. Mudgett and L. W. Richards, “Multiple scattering calculations for technology”, Appl. Opt. 10, p. 1485, 1971). In the literature various approaches as the correction factor method and derived variants are discussed, which all are of approximate character, since for an exact physical/mathematical formulation insufficient information is available. For the realisation of exact theoretical approaches the expenditure is generally much too high and does not have relationship to the gain. In the correction factor approach from the comparison between the formulated and calculated concentrations of a sprayed-out recipe correction factors are generated which approximately allow for a characterisation of the color strength differences between the materials available for the elaboration of color shades and the raw materials used for the generation of optical material parameters. By means of this correction factor procedure subsequently all new calculated recipes are modified. However, this method becomes numerically unstable, if during the correction the amount of one or more recipe components approaches zero.

In addition beyond the actual recipe constituents no further tinting components can be defined.

The objective of the present invention was therefore to avoid the restrictions of conventional methods for recipe correction and to increase the efficiency of shading processes. Furthermore the objective of the present invention was to provide a method for matching reference color formulations to a defined color shade standard, which method reduces the number of tinting steps particularly in color development in color laboratories and batch adjustment in the production of paints. The method shall be applicable to color shade standards of unknown or of known pigmentation.

### SUMMARY OF THE INVENTION

The present invention is directed to a method for matching a reference color formulation to a defined color shade standard of unknown or of known pigmentation comprising the following steps:
1. Measuring a reflectance spectrum R_{ST} of the color shade standard,
2. Mixing a paint according to a recipe for the color shade standard and applying the paint to a substrate,
3. Measuring the reflectance spectrum R_{PT} of the applied paint,
4. Recalculating the theoretical reflectance spectrum R_{RPT} for the recipe of the applied paint,
5. Calculating the difference spectrum ΔR between the measured reflectance spectrum R_{PT} of the applied paint obtained in step 4 and the recalculated reflectance spectrum R_{RPT} obtained in step 5,
6. Adjusting the reflectance spectrum R_{ST} of the color shade standard with the difference spectrum ΔR obtained in step 6, creating a modified reflectance spectrum R_{STM} of the color shade standard,
7. Calculating a recipe on basis of the modified reflectance spectrum R_{STM},
8. Mixing a paint according to the recipe calculated in step 8 and applying the paint to a substrate,
9. Optionally measuring the reflectance spectrum R_{PT} of the applied paint and repeating steps 4 to 8, if the color difference between the reflectance spectrum of the applied paint R_{PT} and the modified reflectance spectrum R_{STM} of the color shade standard is not acceptable. This is done until a given match criterion is fulfilled.

Alternatively the present invention is directed to a method for matching a reference color formulation to a defined color shade standard of unknown or of known pigmentation comprising
1. Determining color coordinates C_{ST} of the color shade standard,
2. Mixing a paint according to a recipe for color shade standard and applying the paint to a substrate,
3. Determining the color coordinates C_{PT} of the applied paint,
4. Recalculating the theoretical color coordinates C_{RPT} for the recipe of the applied paint,
5. Calculating the difference ΔC between the determined color coordinates C_{PT} of the applied paint obtained in step 3 and the recalculated color coordinates C_{RPT} obtained in step 4,
6. Adjusting the color coordinates C_{ST} of the color shade standard with the difference of the color coordinates ΔC obtained in step 5, creating modified color coordinates C_{STM} of the color shade standard,
7. Calculating a recipe on basis of the modified color coordinates C_{STM},
8. Mixing a paint according to the recipe calculated in step 7 and applying the paint to a substrate,
9. Optionally determining the color coordinates C_{PT} of the applied paint and repeating steps 4 to 8 if the color difference between the color coordinates of the applied paint C_{PT} and the modified color coordinates C_{STM} of the color shade standard is not acceptable. This is done until a given match criterion is fulfilled.

The color coordinates as, e.g., the triplet of tristimulus values or the L*, a*, b* values of the CIELab color space can be derived from the measured reflectance spectra in a way well-known to person skilled in the art of colormetrics or can be measured directly with an appropriate measuring device.

It goes without saying that the method of the present invention is applicable if the first tinting step in a color matching process doesn't lead to an acceptable result, i.e., if the sprayed out paint formulated on the basis of the identified recipe for the color shade standard doesn't match the color shade standard and the difference is not acceptable.

### BRIEF DESCRIPTION OF DRAWINGS

FIG. 1 is a schematic flow diagram of the procedure of the present invention.

FIGS. 2 to 4 show the course of development of a green solid color shade comprising five colorants: white, carbon black, yellow, blue, and green.

FIG. 5 shows the change of the target spectrum for a single correction step.

FIG. 6 displays the difference spectrum ΔR between standard and the various performed correction steps.

FIGS. 7 to 11 show the development of a violet gonioapparent color shade comprising a flop control agent (fca) and five colorants: Al, Mica-blue, red, violet, and carbon black. The concentration variation for all recipe constituents is given as a function of tinting steps.

FIG. 7 depicts the reflectance surface of the standard as a function of wavelength and observation angle.

FIG. 8 shows the color difference between standard and sprayed-out recipe as a function of tinting steps.

FIG. 9 displays the concentration variation for all recipe constituents as a function of tinting steps.

FIG. 10 shows the color difference between standard and sprayed-out recipe as a function of tinting steps for the conventional correction factor method

FIG. 11 displays the concentration variation for all recipe constituents as a function of tinting steps for the conventional correction factor method.

### DETAILED DESCRIPTION OF THE EMBODIMENTS

The method of the present invention is based on a comparison of spectral data of measured reflection spectra (or alternatively on a comparison of the corresponding color coordinates) of color shades of known pigmentation and the corresponding theoretical expectation values. The more samples are available, the more information can be collected about the coloristic deviations between the materials used for the pigment calibration and the actually employed raw materials for the color matching. Exploiting the complete information accumulated in all tinting steps so far a procedure for recipe correction of solid and effect color shades with convergence behaviour emerges, when using the method of the present invention. Generally, when using the new method a recipe stabilizes after three to five correction steps. Compared to conventional procedures a termination criterion can be defined, allowing for an almost automation and acceleration of the elaboration process of formulas. Furthermore, the procedure offers the possibility to define further tinting components in addition to the actual recipe constituents. The method can be applied to dry as well as wet paint materials.

The invention will be explained in greater detail below.

The term “reflection spectrum” shall mean reflection spectrum in case of solid color shades and reflection surface in case of special effect color shades.

In step 1 of the present invention the reflectance spectrum R_{ST} of a color shade standard to be matched is measured. Measuring is done with a spectrophotometer at a single measuring geometry (as, e.g., 45°/0° or d/8°) for solid color shades and at multiple measuring geometries by means of a goniospectrophotometer suited for special effect color shades. The color shade standard can be a cured or dried paint layer, a wet paint layer, or any other color standard of arbitrary character. When measuring the reflectance spectrum of wet paint films usual methods and devices for measuring wet paint films can be used.

In step 2 of the present invention a paint sample is mixed according to a recipe for the color shade standard. The paint is mixed according to the known recipe in case of a color shade standard of known pigmentation or according to the calculated recipe in case of a color shade standard of unknown pigmentation.

The color shade standard can be for example a color shade standard of unknown pigmentation, so that first of all a recipe must be calculated for the color shade. The color shade standard can also be a color shade standard of known pigmentation, e.g., a color standard for the production of paints of known composition/pigmentation. In that case the actual paint production batch is to be matched to the given color shade standard.

Therefore in case of color shade standards of unknown pigmentation the color shade standard has to be matched with an available colorant system by calculating a recipe on basis of the measured reflectance spectrum. This is done according to a procedure of recipe calculation well-known to a person skilled in the art. Recipe calculation is usually based on a given colorant system.

Colorant system should be understood to mean any system of absorption pigments and/or special-effect pigments comprising all pigments which shall be used for the production of paints. The number and choice of pigment components are not subject to restrictions here. They may be adapted in any manner to the relevant requirements, e.g. according to the requirements of the paint manufacturer or its customers.

Prerequisite of the recipe calculation is the knowledge of the optical material parameters of all colored constituents of the available colorant system. They have to be determined experimentally in advance for any colorant of the system by means of a calibration echelon. The respective calibration echelon to be produced is of course closely connected to the radiative transfer model utilized. In the isotropic case two material parameters have to be determined, namely the scattering and absorption coefficients, respectively. For this purpose at least two different blends of different coloristic behaviour have to be measured. The model explicitly accounting for the anisotropy of scattering events contains further wavelength-dependent material constants used for the parameterisation of the phase function. In case of a neural network model the optical properties of all pigments are hidden and captured in the weights of the network structure.

Then the paint is applied to a substrate. The subsequent measurement of the reflectance spectrum RPT of the applied paint can be carried out with the wet paint layer or the cured or dried paint layer. Preparation and application of the paint sample can be done in a usual way. The paint can be sprayed out onto metal test panels for example. Optionally the applied paint layer can be cured or dried under desired conditions. Furthermore usual methods and devices for measuring reflectance data of wet paint films can be used. The choice, wet or dried paint layer, depends on the available standard.

Subsequently the reflectance spectrum R_{PT} of the applied paint layer is measured (step 3). This is carried out as explained in step 1 of the present invention.

In step 4 of the present invention the theoretical reflectance spectrum R_{RPT} of the recipe of the applied paint is recalculated. This can be done e.g. before or after carrying out step 2 or before or after carrying out step 3. The theoretical reflectance spectrum R_{PTR} is recalculated on basis of the optical material parameters of the colored pigments of the recipe, which have been experimentally determined in advance and e.g. stored in a database.

In a next step (step 5) the difference spectrum ΔR between the measured reflectance spectrum R_{PT} of the applied paint obtained in step 3 and the recalculated reflectance spectrum R_{RPT} obtained in step 4 is calculated.

In the comparison between the measured reflectance spectrum R_{PT} of the applied paint according to the recipe and the reflection spectrum R_{RPT} theoretically recalculated for the same formula generally differences may be found, which can be traced back to the limits of the standardisation abilities of colorants, the recipe dependent interactions of the coloring components among each other, the finite accuracy of the optical material parameters, limitations of the employed theoretical model, variations in the application conditions, and measuring errors. The difference between measured and recalculated reflectance spectrum is a measure for the mentioned deficiencies.

Therefore in step 6 the reflectance spectrum R_{ST} of the color shade standard is adjusted with the difference spectrum ΔR obtained in step 5 obtaining thereby a modified reflectance spectrum R_{STM} of the color shade standard.

The modified reflectance spectrum of the color shade standard R_{STM} is subsequently matched by usual recipe calculation. This can be done by varying the components of the initial recipe and eventually adding additional defined tinting components, which are available in the given colorant system. A modified recipe on basis of the modified reflectance spectrum R_{STM} is calculated (step 7). The calculated modified recipe is again mixed and sprayed-out. The sprayed-out paint is spectrophotometrically measured.

If the color difference between the reflectance spectrum of the applied paint R_{PT} and the modified reflectance spectrum R_{STM} of the color shade standard is not acceptable, steps 4 to 8 have to be repeated until a given match criterion is fulfilled.

The assessment of the quality of a match can be made strictly visually or instrumentally, or a combination of both approaches may be utilised. In case of an instrumental assessment depending on the area of application (as, e.g., Refinish, Industrial or OEM coating) and associated acceptance solid various metrics may serve as a termination criterion for the color development process. Typically the residual color difference in a uniform color space (as, e.g., CIELab-76 or DIN-99) or a specific color difference formula (as, e.g., CIE94 or CIEDE2000) is adopted for this purpose, where a threshold value is agreed on separating accepted and rejected color regions. In case of gonioapparent colors a generalisation of the formalism has to be made to properly account for the angular dependence of the color appearance.

A strict mathematical termination criterion may be formulated based on an analysis of the convergence properties of the individual concentrations of all recipe components as a function of the number of correction steps. The functional behaviour of the individual concentrations of all components as a function of correction steps has to be approximated by an appropriate model function, which can be fitted to the experimental results by means of an efficient fitting routine to determine the model parameters. For a three-parameter function at least three data sets are needed for the estimation of the fitting parameters: the first sprayed-out recipe, the first sprayed-out correction, and the calculated second correction.

Using the estimated parameter values, the asymptotic behaviour of the model function can be calculated. If the concentration variation with the number of correction steps is correctly described by the model function the instrumental elaboration process can now be terminated by a unique mathematical criterion.

The quality of the asymptotic recipe derived from three parameter sets is closely related to the applicability of the model function and to the influence of statistical and systematic errors. Both error sources inevitably lead to deviations from the “ideal” asymptotic recipe and are discernible in special cases, if for instance the asymptotic concentration of a recipe constituent for a monotonically decreasing (increasing) function is higher (lower) than the value of the last experimental data set (second calculated concentration). It is obvious to disregard this asymptotic recipe and to proceed with a normal recipe correction step. The data accuracy can be improved further by estimating more than three correction steps. The subsequently available fourth data set for the asymptotic reduces the influence of all error sources considerably (over-determined set of equations!) and generally leads to an almost “ideal” corrected asymptotic recipe. At least now the recipe correction procedure can be terminated, since all instrumental potentialities for improvement of a recipe have been exhausted.

Experiments have clearly revealed that the convergence behaviour of the devised method is significantly better than linear and can be approximated by an appropriate model function to a sufficient degree of accuracy. Hence the performance of the correction method is clearly superior to the conventional linearised approach and certainly leads to a reduction in the number of hits in the shading process. The model function can also be utilised to extrapolate to correction step infinite. In this sense a simple analysis tool can be added to the correction scheme to reduce the number of hits by extrapolation and to additionally improve the convergence performance on the one hand, and on the other to establish a tool clearly indicating the limits of instrumental recipe correction (termination criterion).

Generally, the corresponding color coordinates as, e.g., the triplet of tristimulus values or the L*, a*, b* values of the more uniform CIELab color space can be used in the present invention instead of using the reflectance spectra, i.e. instead of a spectral match criterion a color space match criterion can also be applied.

The color coordinates, e.g. the triplet of tristimulus values or the L*, a*, b* values of the CIELab color space can be derived from the measured reflectance spectra in a way well-known to a person skilled in the art or can be measured directly with an appropriate measuring device.

For carrying out the method of the present invention the order of steps 1 to 9 is not rigidly fixed. All steps are used to carry out the method of the present invention, but if appropriate order of steps can be changed, e.g. step 4 can be done before or after step 2 or before or after step 3. A person skilled in the art is able to evaluate any appropriate logical order of steps.

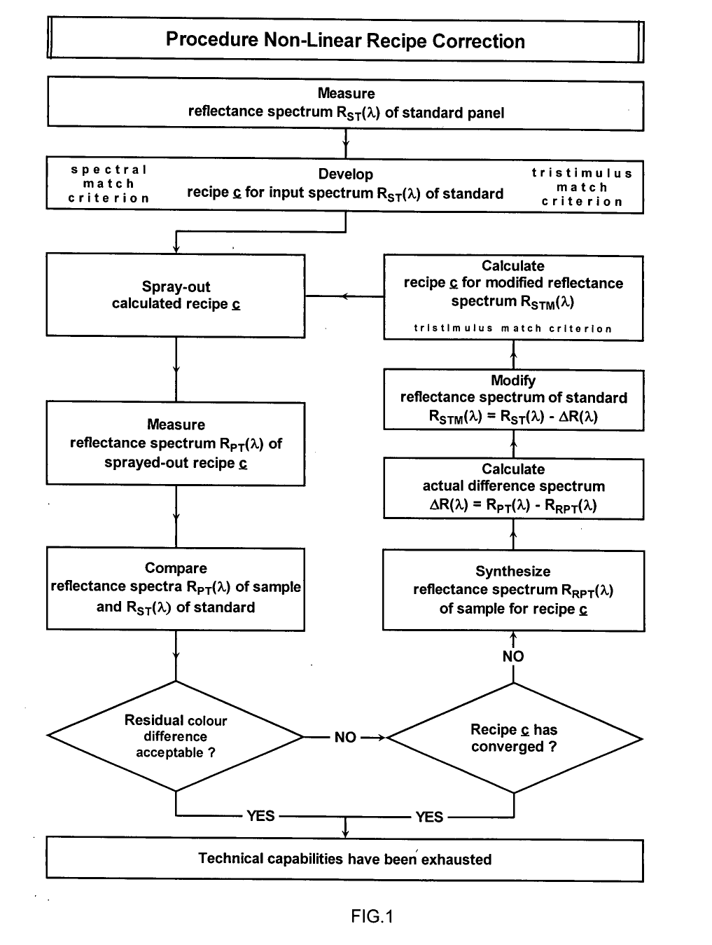

A schematic flow diagram of the procedure of the present invention is given in FIG. 1.

A standard panel of unknown pigmentation is used as color shade standard.

Generally the spectrum of the color shade standard is adjusted with the spectral difference between the measured spectrum R_{PT} of the applied paint and the corresponding recalculated spectrum R_{RPT} for the same formula. For this modified new spectrum of the color shade standard again a new recipe is calculated based on the components used so far and eventually further tinting components. The described procedure is repeated until a defined termination criterion is fulfilled. This means that the procedure is repeated until the corrected color recipe has stabilized (i.e., the change of the concentrations of all components is sufficiently small or falls short of a given limiting value, respectively) and/or the remaining color difference hits a pre-set tolerance frame.

The spectral difference ΔR (ΔR=R_{PT}−R_{PTR}) between experimental sample spectrum and the corresponding predicted reflectance spectrum is a measure of the total process error including failures of the radiative transfer model, variations in the physical structure of the characterisation data and mistakes in processing as, e.g., incorrect colorant weighing or wrong application conditions. The latter two systematic error sources generally introduce an erratic component into the correction process having a negative impact on the convergence properties of any recipe correction method.

Compared to that, e.g., the known linear vector shading method does not make use of all information generated in the course of the correction process. Only the color difference between the standard and e.g. the actual batch is considered, while the misfit between actual and predicted batch color positions or reflectance functions is totally ignored.

If these systematic error contributions dominate the total process error, no convergence within the limits defined by their behaviour can be expected, since the target is moving randomly. Only a tighter process control will help to re-establish a well-behaved recipe correction algorithm.

The correction method of the present invention offers the advantage of excellent convergence properties, whereby the number of correction steps can be restricted in a natural way. The convergence is sufficiently fast for all potential operational areas; in any case the procedure comes to a halt after three to five steps. A unique termination criterion indicating instrumental limitations of recipe correction could be defined. Due to these optimal properties of the correction procedure the elaboration of color shades or tinting of batches to a great extent can be automated. Furthermore, in the course of correction additional tinting components beyond the actual recipe constituents can be defined informally and used for the optimisation of the match results. The existing restriction of the correction factor method, namely that in the course of the correction no component can be thrown out of the recipe (numerical instability of the correction factor method), does as well no longer exist in the new procedure.

The direct approach to the difference in optical behaviour of the materials used for pigment calibration and the colorants available for the elaboration of a color shade is offered by a comparison between the measured reflectance spectrum of a color shade and the recalculated spectrum of the corresponding formula. Only in this way specific spectral differences can be made transparent and accounted for in the correction. Using this spectral information the reflectance spectrum of the standard is modified and subsequently matched again. Other procedures, as e.g., the method of correction factors, compare the concentrations of two recipes and as such fall back on already transformed quantities that no longer contain direct spectral information. The risk of metameric corrections is minimised by comparing spectral data, since within the algorithm for the actual correction step, which is based on a conventional color recipe calculation for the modified spectrum of the standard, the figure of merit of the iteration is the optimum curve fitting applying a suitable weighting function.

Finally the present invention provides a highly flexible and effective procedure for recipe correction to match a given color shade standard which can be used for elaboration of color shades and color development in color laboratories as well as for batch adjustment in production of paints.

The invention is explained more detailed in the following examples.

### EXAMPLES

### Example 1

### Recipe Correction of a Green Solid Color Shade

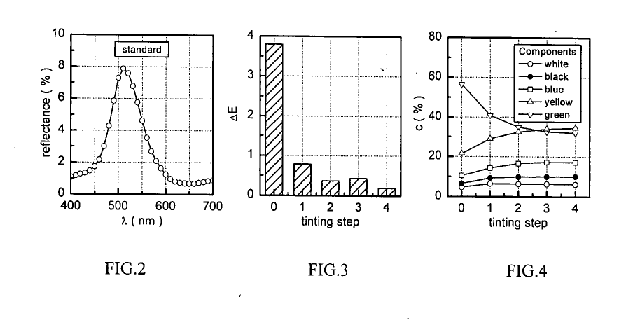

FIGS. 2 to 4 show the course of development of a green solid color shade comprising the five colorants white, carbon black, yellow, blue, and green. The standard contains a green pigment and a second green component made of the complementary colors yellow and blue. Such complementary colors are known to react quite sensitive to changes of the amounts of ingredients.

FIG. 2 depicts the reflectance spectrum of the standard as a function of wavelength measured with a spectrophotometer.

FIG. 3 shows the color difference between standard and sprayed-out recipe as a function of tinting steps.

FIG. 4 displays the concentration variation for all recipe constituents as a function of tinting steps.

Through the consideration of all information collected at each correction step the new procedure leads to a significant improvement of the recipe from a coloristic point of view, as can be seen from the on the average decreasing residual color difference. Also the dependence of the amounts of all recipe components with increasing number of correction steps exhibits an unambigious tendency towards stable values. As expected, the convergence behaviour of the devised spectral correction method in color space is clearly better than linear and is obviously superior to the linear vector shading approach.

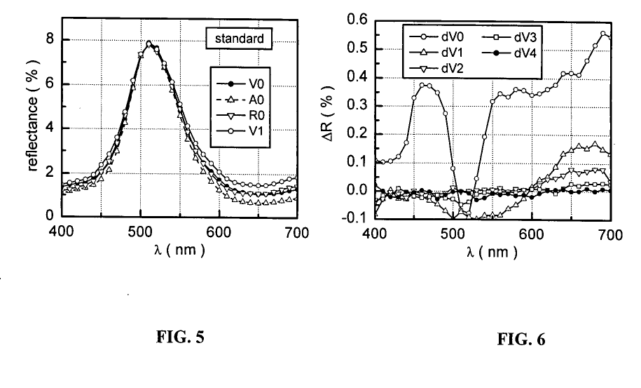

FIGS. 5 and 6 collect more details on the course of recipe correction in reflectance space. FIG. 5 shows the change of the target spectrum for a single correction step.

FIG. 6 displays the difference spectrum ΔR between standard and the various performed correction steps, impressively vindicates the theoretical expectation that ΔR rapidly diminishes with increasing number of correction steps to a level the statistical measurement error.

The curve labelled “V0” represents the measured reflectance spectrum of the standard (RST). The corresponding predicted match for this standard gives rise to the theoretically expected “R0” curve (RPT). When mixing and spraying out this recipe and measuring the panel leads to the “A0” curve (RPT). The difference of the theoretically synthesized spectrum “R0” and the actually measured spectrum “A0” (RPT) is due to all inherent preparatory, application, measurement, and model errors of the entire process including the misfit of the characterisation data set. Subtracting this difference spectrum ΔR=R0−A0 from the spectrum “V0” of the standard creates a new virtual target spectrum (V1=RSTM) that accounts for the total process error. Therefore, matching of this virtual target is expected to provide results considerably closer to the final stationary solution of the matching problem than the previous step.

After two tinting steps the recipe has been stabilized when using the method according to the invention. A satisfactory matching result has been achieved.

### Example 2

### Recipe Correction of a Special Effect Color Shade

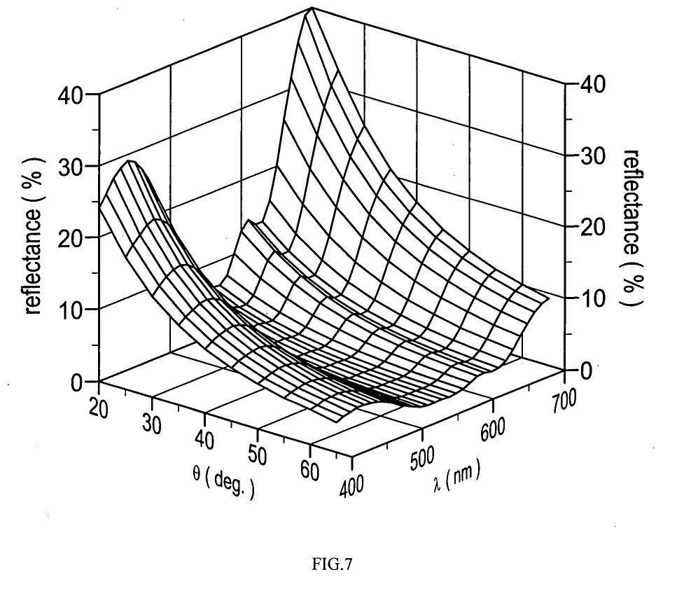

FIGS. 7 to 11 show the course of a completely automated recipe correction of a special effect color shade using the procedure of the present invention in comparison to the conventional correction factor method, which has been implemented as single-step procedure.

FIGS. 7 to 11 show the development of a violet gonioapparent color shade comprising a flop control agent (fca) and five colorants: Al, Mica-blue, red, violet, and carbon black. The concentration variation for all recipe constituents is given as a function of tinting steps as well as the extrapolated asymptotic values derived from three, four, and five data sets.

FIG. 7 depicts the reflectance surface of the standard as a function of wavelength and observation angle.

FIG. 8 shows the color difference between standard and sprayed-out recipe as a function of tinting steps.

FIG. 9 displays the concentration variation for all recipe constituents as a function of tinting steps.

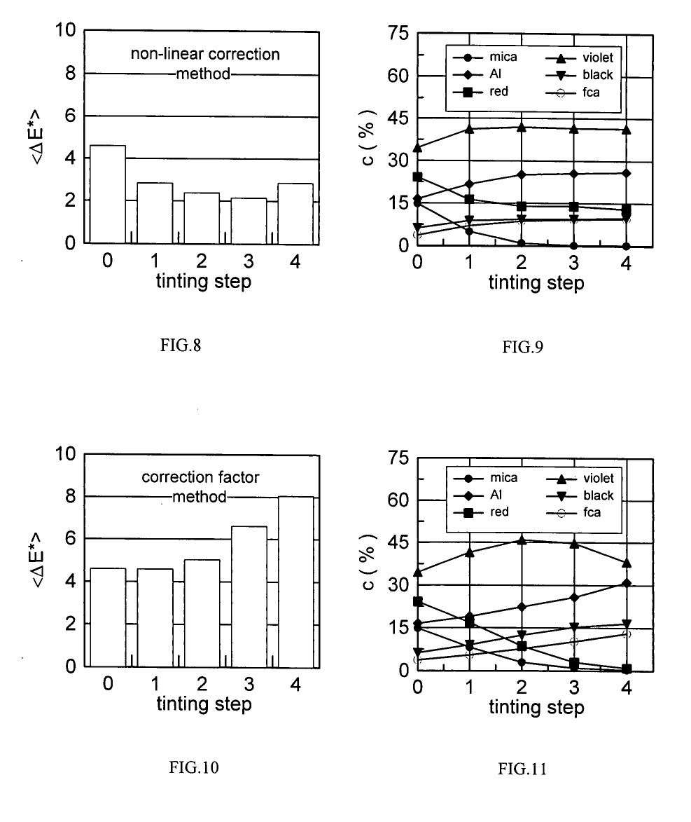

FIG. 10 shows the color difference between standard and sprayed-out recipe as a function of tinting steps for the conventional correction factor method

FIG. 11 displays the concentration variation for all recipe constituents as a function of tinting steps for the conventional correction factor method.

The special effect color shade contains as coloring constituents two interference pigments and three solid pigments. As can be seen from the reflection indicatrix depicted in FIG. 7 the effect character of this color shade becomes obvious in the angular variation. Furthermore, in FIG. 8 and FIG. 9 the remaining color differences according to CIELab-76 and the recipe composition as a function of correction steps have been integrated. While according to the known single-step method of correction factors no improvement could be achieved with the correction calculation, the new procedure due to the consideration of all information collected at every step leads to a significant improvement of the recipe from a coloristic point of view, as can be seen from the decreasing mean residual color difference. In the latter case also the dependence of the amounts of all recipe constituents shows a clear tendency towards stable values with increasing number of correction steps, while the correction factor method does not show any saturation tendency at all. In the discussed example the efficiency of the new correction method becomes obvious in the fact, that due to the relatively small residual color difference of the sprayed-out first recipe the conventional correction procedure from the tendency leads to a deterioration of the recipe (pathological case), while the new method handles also this limiting case in a completely unproblematic way.

After three tinting steps the recipe has been stabilized when using the method of the present invention. A satisfactory matching result has been achieved.

What we claim is:

1. A method for matching a reference color formulation to a defined color shade standard comprising
1. Measuring a reflectance spectrum R_{ST} of the color shade standard,
2. Mixing a paint according to a recipe for the color shade standard and applying the paint to a substrate,
3. Measuring a reflectance spectrum R_{PT} of the applied paint,
4. Recalculating the theoretical reflectance spectrum R_{RPT} for the recipe of the applied paint,
5. Calculating the difference spectrum ΔR between the measured reflectance spectrum R_{PT} of the applied paint obtained in step 3 and the recalculated reflectance spectrum R_{RPT} obtained in step 4,
6. Adjusting the reflectance spectrum R_{ST} of the color shade standard with the difference spectrum ΔR obtained in step 5, creating a modified reflectance spectrum R_{STM} of the color shade standard,
7. Calculating a recipe on basis of the modified reflectance spectrum R_{STM},
8. Mixing a paint according to the recipe calculated in step 7 and applying the paint to a substrate.

2. Method of claim 1, wherein the reflectance spectrum R_{PT} of the paint applied in step 8 is measured and steps 4 to 8 are repeated, if the residual color difference between the reflectance spectrum of the applied paint R_{PT} and the modified reflectance spectrum R_{STM} of the color shade standard is still not acceptable.

3. A method for matching a reference color formulation to a defined color shade standard comprising
1. Determining color coordinates C_{ST} of the color shade standard,
2. Mixing a paint according to a recipe for the color shade standard and applying the paint to a substrate,
3. Determining the color coordinates C_{PT} of the applied paint,
4. Recalculating the theoretical color coordinates C_{RPT} for the recipe of the applied paint,
5. Calculating the difference ΔC between the determined color coordinates C_{PT} of the applied paint obtained in step 3 and the recalculated color coordinates C_{RPT} obtained in step 4,
6. Adjusting the color coordinates C_{ST} of the color shade standard with the difference of the color coordinates ΔC obtained in step 5, creating modified color coordinates C_{STM} of the color shade standard,
7. Calculating a recipe on basis of the modified color coordinates C_{STM},
8. Mixing a paint according to the recipe calculated in step 7 and applying the paint to a substrate.

4. Method of claim 3, wherein the color coordinates C_{PT} of the paint applied in step 8 are experimentally determined and steps 4 to 8 are repeated, if the residual color difference between the color coordinates of the applied paint C_{PT} and the modified color coordinates C_{STM} of the color shade standard is still not acceptable.

5. The method of claim 2, wherein steps 4 to 8 are repeated until a given termination criterion is fulfilled.

6. The method of claim 4, wherein steps 4 to 8 are repeated until a given termination criterion is fulfilled.

7. The method of claim 5 or claim 6, wherein the termination criterion is a mathematical termination criterion based on an analysis of the convergence properties of the individual concentrations of all recipe components as a function of the number of correction steps.

8. The method of claim 1 for elaboration of color shades.

9. The method of claim 3 for elaboration of color shades.

10. The method of claim 1 for batch adjustment in production of paints.

11. The method of claim 3 for batch adjustment in production of paints.
